(19) United States
(12) Patent Application Publication
(10) Pub. No.: US 2025/0003814 A1
(43) Pub. Date: Jan. 2, 2025

(54) SMART ENCLOSURES FOR BATTERIES IN CONSUMER ELECTRONICS

(71) Applicant: Apple Inc., Cupertino, CA (US)

(72) Inventors: Mona Shirpour, San Jose, CA (US); Alan R. Gilchrist, Cupertino, CA (US); Shabab Amiruddin, Pacifica, CA (US); Ryan J. Balliet, Palo Alto, CA (US); Nathan J. Bohney, Encinitas, CA (US)

(21) Appl. No.: 18/680,808

(22) Filed: May 31, 2024

Related U.S. Application Data
(60) Provisional application No. 63/524,604, filed on Jun. 30, 2023.
(60) Provisional application No. 63/540,573, filed on Sep. 26, 2023.

(51) Int. Cl. G01L 1/20; H01M 10/42; H01M 10/44; H01M 10/48

(52) U.S. Cl. CPC G01L 1/20; H01M 10/44; H01M 10/48; H01M 2010/4271; H01M 2200/20

(57) ABSTRACT

A battery includes an enclosure, a battery management unit (BMU), a conductive trace including conductive particles disposed on a surface of the enclosure and electrically coupled with the BMU to form a closed-loop electrical path. The BMU is configured to detect a resistance in the closed-loop electrical path caused by a percolation of the conductive particles, and determine a swollen condition of the battery based on the resistance.

### CROSS-REFERENCE TO RELATED APPLICATIONS

This application claims priority to U.S. Provisional Application No. 63/524,604, entitled “SMART ENCLOSURES FOR BATTERIES IN CONSUMER ELECTRONICS,” filed Jun. 30, 2023, and U.S. Provisional Application No. 63/540,573, entitled “SMART ENCLOSURES FOR BATTERIES IN CONSUMER ELECTRONICS,” filed Sep. 26, 2023, which are hereby incorporated by reference in their entireties for all purposes.

### BACKGROUND

The present disclosure relates generally to batteries, such as secondary or rechargeable batteries (e.g., lithium-ion batteries, lithium iron phosphate batteries, lithium-ion polymer batteries, nickel-cadmium batteries, nickel-metal hydride batteries, lead-acid batteries, etc.), and more specifically to swell detection of such batteries.

Batteries such as those described above may be employed in a variety of consumer electronic applications. In certain operating conditions, a battery may swell over a lifetime of the battery. Unfettered battery swelling may negatively affect the battery and/or a load (e.g., consumer electronic) powered by the battery.

Traditional techniques for detecting and/or mitigating swell in a battery may substantially increase a size of the battery, reduce a volumetric energy density of the battery, contribute to a cost of the battery, or any combination thereof. Further, in certain traditional embodiments, swell detection features may not be employed due to the above-described constraints. Accordingly, it is now recognized that improved systems and methods are desired.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In an embodiment, a battery includes an enclosure, a battery management unit (BMU), and a conductive trace including conductive particles disposed on a surface of the enclosure and electrically coupled with the BMU to form a closed-loop electrical path. The BMU is configured to detect a resistance in the closed-loop electrical path caused by percolation of the conductive particles. Further, the BMU is configured to determine a swollen condition of the battery based on the resistance.

In another embodiment, a battery includes an enclosure, a percolation-based conductive trace including conductive particles disposed on a surface of the enclosure, and a battery management unit (BMU) coupled with the percolation-based conductive trace. The BMU is configured to detect a resistance in the percolation-based conductive trace, and determine a swollen condition of the battery based on the resistance

In another embodiment, one or more tangible, non-transitory, computer-readable media store instructions thereon that, when executed by one or more processors, are configured to cause the one or more processors to perform various functions. The functions include detecting a resistance in a closed-loop electrical path caused by a percolation of conductive particles disposed on a surface of a battery. The functions also include determining a swollen condition of the battery based on the resistance.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings described below in which like numerals refer to like parts.

FIG. 1 is a block diagram of an electronic device, according to embodiments of the present disclosure;

FIG. 2 is a block diagram of a battery including a battery swelling detection assembly, according to embodiments of the present disclosure;

FIG. 3 is a schematic front view of the battery of FIG. 2, where the battery is in a fresh (e.g., unswollen) condition, according to embodiments of the present disclosure;

FIG. 4 is a schematic front view of the battery of FIG. 2, where the battery is in a swollen condition, according to embodiments of the present disclosure;

FIG. 5 is a schematic illustration of a conductive trace of the battery swelling detection assembly of FIG. 2, reflective of the fresh (e.g., unswollen) condition of the battery in FIG. 3, according to embodiments of the present disclosure;

FIG. 6 is a schematic illustration of a conductive trace of the battery swelling detection assembly of FIG. 2, reflective of the swollen condition of the battery in FIG. 4, according to embodiments of the present disclosure;

FIG. 7 is a graph illustrating a relationship (e.g., correlation) between amount of swelling of the battery of FIG. 2 and a resistance in a conductive trace of the battery swelling detection assembly of the battery of FIG. 2, according to embodiments of the present disclosure;

FIG. 8 is an exploded perspective view of a portion of the battery of FIG. 2, including various features of the battery swelling detection assembly (e.g., a conductive trace formed by conductive particles, a battery management unit or BMU, etc.), according to embodiments of the present disclosure;

FIG. 9 is a front view of the battery of FIG. 2, where the battery swelling detection assembly includes a conductive trace formed by conductive particles and having an L-shape, according to embodiments of the present disclosure;

FIG. 10 is a front view of the battery of FIG. 2, where the battery swelling detection assembly includes a conductive trace formed by conductive particles and having a shape other than the L-shape illustrated in FIG. 9, according to embodiments of the present disclosure;

FIG. 11 is a table including various materials that may be included in a conductive trace (e.g., formed by conductive particles) of the battery swelling detection assembly of the battery of FIG. 1, according to embodiments of the present disclosure; and

FIG. 12 is a process flow diagram illustrating a method of detecting a swollen condition of the battery of FIG. 2 via the battery swelling detection assembly, according to embodiments of the present disclosure.

### DETAILED DESCRIPTION OF SPECIFIC EMBODIMENTS

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the particular features, structures, or characteristics may be combined in any suitable manner in one or more embodiments. Use of the terms “approximately,” “near,” “about,” “close to,” and/or “substantially” should be understood to mean including close to a target (e.g., design, value, amount), such as within a margin of any suitable or contemplatable error (e.g., within 0.1% of a target, within 1% of a target, within 5% of a target, within 10% of a target, within 25% of a target, and so on). Moreover, it should be understood that any exact values, numbers, measurements, and so on, provided herein, are contemplated to include approximations (e.g., within a margin of suitable or contemplatable error) of the exact values, numbers, measurements, and so on).

This disclosure is directed to batteries, such as secondary or rechargeable batteries (e.g., lithium-ion batteries, lithium iron phosphate batteries, lithium-ion polymer batteries, nickel-cadmium batteries, nickel-metal hydride batteries, lead-acid batteries, etc.), and/or other types of batteries employed, for example, in consumer electronics. More specifically, the present disclosure is directed to techniques for detecting a swollen condition of such batteries.

For example, a battery may include an enclosure, various componentry (e.g., electrodes, a separator, electrolyte) disposed within the enclosure, and a battery management unit (BMU). The BMU, sometimes referred to as a battery management system (BMS), may include various componentry (e.g., processing circuitry, memory circuitry, sensors, etc.) configured to monitor operational aspects of the battery and protect the battery from operating outside of normal conditions (e.g., normal voltages, temperatures, currents, etc.).

In accordance with the present disclosure, a conductive trace formed by conductive particles may be disposed in or on a surface of the enclosure and electrically coupled with the BMU to form a closed-loop electrical path. The BMU may be configured to apply (e.g., provide) a current to the closed-loop electrical path and detect a change in a resistance in the closed-loop electrical path caused by a percolation of the conductive particles. For example, in an unswollen condition of the battery, a first resistance in the closed-loop electrical path may be detected by the BMU, where the first resistance is indicative of the unswollen condition. As the battery swells, percolation of the conductive particles of the closed-loop electrical path may cause a disruption in the closed-loop electrical path. For example, percolation of the conductive particles may refer to a reduction in a density of the conductive particles and/or an increase in a distance between the conductive particles along the closed-loop electrical path, which may be caused by movement of the conductive particles with the swelling surface of the enclosure of the battery.

The above-described consequences of battery swelling may cause a change (e.g., increase) in the resistance in the closed-loop electrical path. With the battery in the swollen condition, the BMU may detect a second resistance in the closed-loop electrical path, where the second resistance is greater than the first resistance, indicating the swollen condition of the battery. In some embodiments, the BMU may compare the second resistance with a resistance threshold, and determine the swollen condition of the battery based on the second resistance exceeding the resistance threshold. Additionally or alternatively, the BMU may compare a resistance differential between the first resistance and the second resistance with a resistance differential threshold, and determine the swollen condition of the battery based on the resistance differential exceeding the resistance differential threshold.

The above-described features may improve a safety of operating the battery over traditional embodiments that do not include swell detection, improve (e.g., reduce) a size of the battery over traditional embodiments employing other swell detection techniques, improve (e.g., reduce) a cost of monitoring battery swelling over traditional embodiments employing other swell detection techniques, and/or enable swell detection without sensor componentry external to the battery (i.e., the sensing componentry is not free-standing), among other technical benefits.

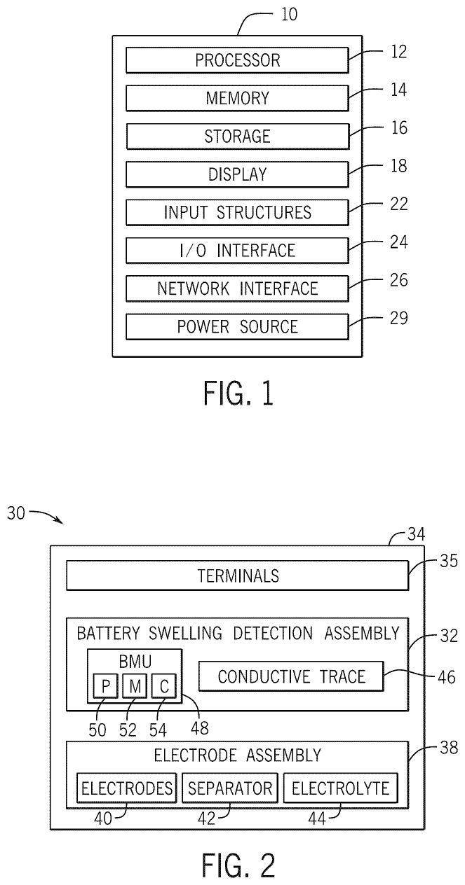

Continuing now with the drawings, FIG. 1 is a block diagram of an electronic device 10, according to embodiments of the present disclosure. The electronic device 10 may include, among other things, one or more processors 12 (collectively referred to herein as a single processor for convenience, which may be implemented in any suitable form of processing circuitry), memory 14, nonvolatile storage 16, a display 18, input structures 22, an input/output (I/O) interface 24, a network interface 26, and a power source 29. The various functional blocks shown in FIG. 1 may include hardware elements (including circuitry), software elements (including machine-executable instructions) or a combination of both hardware and software elements (which may be referred to as logic). The processor 12, memory 14, the nonvolatile storage 16, the display 18, the input structures 22, the input/output (I/O) interface 24, the network interface 26, and/or the power source 29 may each be communicatively coupled directly or indirectly (e.g., through or via another component, a communication bus, a network) to one another to transmit and/or receive signals between one another. It should be noted that FIG. 1 is merely one example of a particular implementation and is intended to illustrate the types of components that may be present in the electronic device 10.

By way of example, the electronic device 10 may include any suitable computing device, including a desktop or notebook computer, a portable electronic or handheld electronic device such as a wireless electronic device or smartphone, a tablet, a wearable electronic device, and other similar devices. In additional or alternative embodiments, the electronic device 10 may include an access point, such as a base station, a router (e.g., a wireless or Wi-Fi router), a hub, a switch, and so on. It should be noted that the processor 12 and other related items in FIG. 1 may be embodied wholly or in part as software, hardware, or both. Furthermore, the processor 12 and other related items in FIG. 1 may be a single contained processing module or may be incorporated wholly or partially within any of the other elements within the electronic device 10. The processor 12 may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that may perform calculations or other manipulations of information. The processors 12 may include one or more application processors, one or more baseband processors, or both, and perform the various functions described herein.

In the electronic device 10 of FIG. 1, the processor 12 may be operably coupled with a memory 14 and a nonvolatile storage 16 to perform various algorithms. Such programs or instructions executed by the processor 12 may be stored in any suitable article of manufacture that includes one or more tangible, computer-readable media. The tangible, computer-readable media may include the memory 14 and/or the nonvolatile storage 16, individually or collectively, to store the instructions or routines. The memory 14 and the nonvolatile storage 16 may include any suitable articles of manufacture for storing data and executable instructions, such as random-access memory, read-only memory, rewritable flash memory, hard drives, and optical discs. In addition, programs (e.g., an operating system) encoded on such a computer program product may also include instructions that may be executed by the processor 12 to enable the electronic device 10 to provide various functionalities.

In certain embodiments, the display 18 may facilitate users to view images generated on the electronic device 10. In some embodiments, the display 18 may include a touch screen, which may facilitate user interaction with a user interface of the electronic device 10. Furthermore, it should be appreciated that, in some embodiments, the display 18 may include one or more liquid crystal displays (LCDs), light-emitting diode (LED) displays, organic light-emitting diode (OLED) displays, active-matrix organic light-emitting diode (AMOLED) displays, or some combination of these and/or other display technologies.

The input structures 22 of the electronic device 10 may enable a user to interact with the electronic device 10 (e.g., pressing a button to increase or decrease a volume level). The I/O interface 24 may enable electronic device 10 to interface with various other electronic devices, as may the network interface 26. In some embodiments, the I/O interface 24 may include an I/O port for a hardwired connection for charging and/or content manipulation using a standard connector and protocol, such as the Lightning connector, a universal serial bus (USB), or other similar connector and protocol. The network interface 26 may include, for example, one or more interfaces for a personal area network (PAN), such as an ultra-wideband (UWB) or a BLUETOOTH® network, a local area network (LAN) or wireless local area network (WLAN), such as a network employing one of the IEEE 802.11x family of protocols (e.g., WI-FI®), and/or a wide area network (WAN), such as any standards related to the Third Generation Partnership Project (3GPP), including, for example, a 3rd generation (3G) cellular network, universal mobile telecommunication system (UMTS), 4th generation (4G) cellular network, Long Term Evolution® (LTE) cellular network, Long Term Evolution License Assisted Access (LTE-LAA) cellular network, 5th generation (5G) cellular network, and/or New Radio (NR) cellular network, a 6th generation (6G) or greater than 6G cellular network, a satellite network, a non-terrestrial network, and so on. In particular, the network interface 26 may include, for example, one or more interfaces for using a cellular communication standard of the 5G specifications that include the millimeter wave (mmWave) frequency range (e.g., 24.25-300 gigahertz (GHz)) that defines and/or enables frequency ranges used for wireless communication. The network interface 26 of the electronic device 10 may allow communication over the aforementioned networks (e.g., 5G, Wi-Fi, LTE-LAA, and so forth).

The network interface 26 may also include one or more interfaces for, for example, broadband fixed wireless access networks (e.g., WIMAX®), mobile broadband Wireless networks (mobile WIMAX®), asynchronous digital subscriber lines (e.g., ADSL, VDSL), digital video broadcasting-terrestrial (DVB-T®) network and its extension DVB Handheld (DVB-H®) network, ultra-wideband (UWB) network, alternating current (AC) power lines, and so forth.

The power source 29 of the electronic device 10 may include any suitable source of power, such as a rechargeable lithium polymer (Li-poly) battery and/or an alternating current (AC) power converter. In accordance with embodiments of the present disclosure, the battery of the power source 29 may include, for example, a battery swelling detection assembly configured to detect when the battery is in a swollen condition. The battery, the battery swelling detection assembly, and related features are described in detail below.

FIG. 2 is a block diagram of an embodiment of a battery 30 (e.g., battery cell) including a battery swelling detection assembly 32. The battery 30 may correspond to, for example, the power source 29 of the electronic device 10 of FIG. 1. However, it should be understood that the battery 30 may be employed in other contexts (e.g., contexts besides consumer electronics, such as electrical vehicles).

In accordance with the present disclosure, the battery 30 includes an enclosure 34 (e.g., housing, pouch, etc.) configured to house various componentry of the battery 30, such the battery swelling detection assembly 32 (or portions thereof), terminals 35 (or portions thereof), and an electrode assembly 38. In some embodiments, portions of the terminals 35 (or “tabs”) protrude from openings in the enclosure 34 such that the portions are exposed for coupling to a load. The electrode assembly 38 includes electrodes 40, such as one or more anodes and one or more cathodes, one or more separators 42, and electrolyte 44.

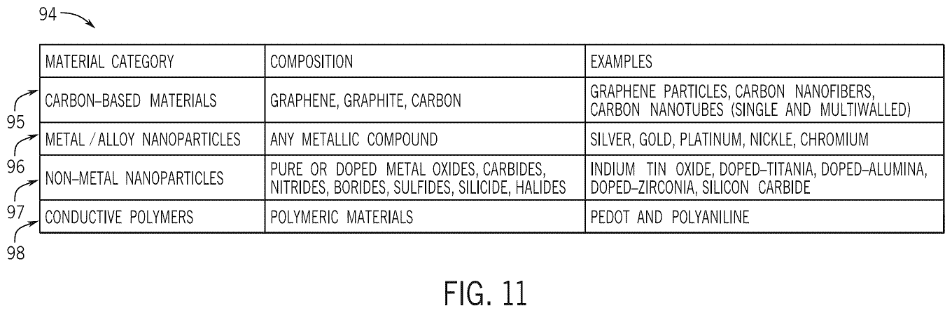

In the illustrated embodiment, the battery swelling detection assembly 32 includes a conductive trace 46 formed, for example, by various conductive particles disposed on a surface (e.g., internal or external surface) of the enclosure 34. Example materials corresponding to the conductive trace 46 (e.g., of the conductive particles) will be described in detail with reference to FIG. 11. A battery management unit (BMU) 48 may also be a part of the battery swelling detection assembly 32, although it should be understood that the BMU 48 may perform other functions, such as monitoring other operational aspects of the battery 30 and protecting the battery 30 from operating outside of normal conditions (e.g., normal voltages, temperatures, currents, etc.). For example, the BMU 48 includes processing circuitry 50, memory circuitry 52 storing instructions thereon executable by the processing circuitry 50 to perform various functions, and communication circuitry 54 configured to enable the BMU 48 to interact with various componentry of the battery 30 and/or a load powered by the battery 30. Depending on the embodiment, the BMU 48 may be disposed inside the enclosure 34, outside of the enclosure 34 (e.g., on an external surface of the enclosure 34), or partially inside the enclosure 34 and partially outside the enclosure 34.

The conductive trace 46, which includes conductive particles as described above, is electrically coupled with the BMU 48 to form a closed-loop electrical path. In some embodiments, the BMU 48 applies (e.g., provides) a current to the closed-loop electrical path and/or detects a resistance in the closed-loop electrical path. When the battery 30 is in a fresh (e.g., unswollen) condition, a density of the conductive particles of the conductive trace 46 is relatively large, while a spacing between adjacent conductive particles of the conductive trace 46 is relatively small. When the battery 30 is in a swollen condition, the density of the conductive particles of the conductive trace 46 decreases as the spacing between adjacent conductive particles increases.

The above-described phenomena may be referred to by the present disclosure as “percolation” of the conductive particles of the conductive trace 46 (e.g., percolation-based conductive trace 46). Such percolation, which causes the density of the conductive particles to decrease and the spacing between adjacent conductive particles to increase as described above, causes a resistance in the conductive trace 46 to increase. The BMU 48 may identify the swollen condition of the battery 30 in response to detecting or otherwise determining an increase in the resistance in the conductive trace 46. For example, the BMU 48 may determine that the resistance in the conductive trace 46 is greater than a threshold resistance. Additionally or alternatively, the BMU 48 may determine that a change in the resistance (e.g., a difference between a first resistance when the battery 30 is in the fresh condition and a second resistance when the battery 30 is in the swollen condition) exceeds a threshold change (e.g., threshold resistance differential). In this way, in certain embodiments, minor swelling generally associated with normal operation of the battery 30 may be ignored, while abnormal or undesirable amounts of swelling (e.g., greater than a threshold amount) may be identified.

In some embodiments, the BMU 48 performs an action (e.g., a control action) in response to identifying the swollen condition of the battery 30. For example, the BMU 48 may communicate an alert, such as transmitting an alert to an external device, displaying an alert on a display of a device (e.g., the display 18 of the device 10 of FIG. 1) or other load being powered by the battery 30, reducing power supplied by the battery 30, disconnecting the battery 30 from the device or other load, disconnecting the battery 30 from a charging source, etc. These and other aspects of the present disclosure are described in detail below with reference to other drawings.

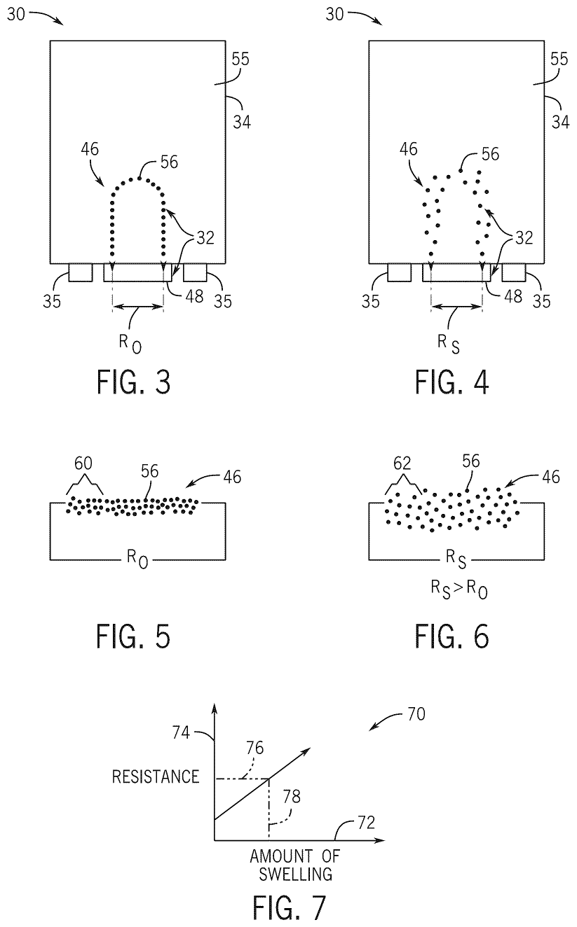

FIG. 3 is a schematic front view of an embodiment of the battery 30 of FIG. 2, where the battery 30 is in a fresh (e.g., unswollen) condition. FIG. 4 is a schematic front view of an embodiment of the battery 30 of FIG. 2, where the battery 30 is in a swollen condition. In FIGS. 3 and 4, the conductive trace 46 of the battery swelling detection assembly 32 is formed by a number of conductive particles 56 disposed on a surface 55 (e.g., internal or external surface) of the enclosure 34 of the battery 30. Further, the conductive particles 56 are more tightly packed when the battery 30 is in the fresh (e.g., unswollen) condition, as illustrated in FIG. 3, than when the battery 30 is in the swollen condition, as illustrated in FIG. 4. That is, in FIG. 3, the conductive particles 56 are more densely arranged and with less space therebetween than in FIG. 4. Indeed, as the battery 30 (and, thus, the surface 55 of the enclosure 34) swells, the conductive particles 56 move along with the movement of the surface 55. Example materials corresponding to the conductive trace 46 (e.g., of the conductive particles 56) will be described in detail with reference to FIG. 11.

The BMU 48 of the battery swelling detection assembly 32 is electrically coupled with the conductive trace 46, as shown in FIGS. 3 and 4, and measures or otherwise determines a resistance in the conductive trace 46. For example, in FIG. 3, the BMU 48 determines that the resistance in the conductive trace 46 is R₀, and in FIG. 3, the BMU 48 determines that the resistance in the conductive trace 46 is Rₛ. In general, Rₛ is typically larger than R₀, which indicates the swollen condition of the battery 30. For example, FIG. 5 is a schematic illustration of an embodiment of the conductive trace 46 (e.g., including the conductive particles 56) of the battery swelling detection assembly 32 of FIG. 2, reflective of the fresh (e.g., unswollen) condition of the battery 30 in FIG. 3, and FIG. 6 is a schematic illustration of an embodiment of the conductive trace 46 (e.g., including the conductive particles 56) of the battery swelling detection assembly 32 of FIG. 2, reflective of the swollen condition of the battery 30 in FIG. 4. As shown, a spacing 60 between adjacent conductive particles 56 in FIG. 5 is less than a spacing 62 of adjacent conductive particles 56 in FIG. 6. Put differently, a density of the conductive particles 56 in FIG. 5 is greater than a density of the conductive particles 56 in FIG. 6. For at least these reasons, Rₛ is greater than R₀.

FIG. 7 is a graph 70 illustrating a relationship (e.g., correlation) between amount of swelling of the battery 30 of FIG. 2 (i.e., corresponding to the X-axis 72) and a resistance in the conductive trace 46 of the battery swelling detection assembly 32 of the battery 30 (i.e., corresponding to the Y-axis 74) of FIG. 2. As shown and described above, the resistance 74 increases as the amount of swelling 72. In the illustrated graph, the relationship between the resistance 74 in the amount of swelling 72 is linear. However, it should be understood that the relationship may be non-linear in certain embodiments. Further, in some embodiments, the BMU 48 (e.g., illustrated in FIGS. 1-3) may identify the swollen condition of the battery 30 when the resistance exceeds a threshold resistance 76. For example, the threshold resistance 76 may be indicative of a threshold amount of swelling 78 that is considered abnormal, undesirable, or otherwise indicative of the battery 30 approaching or reaching an end-of-life condition.

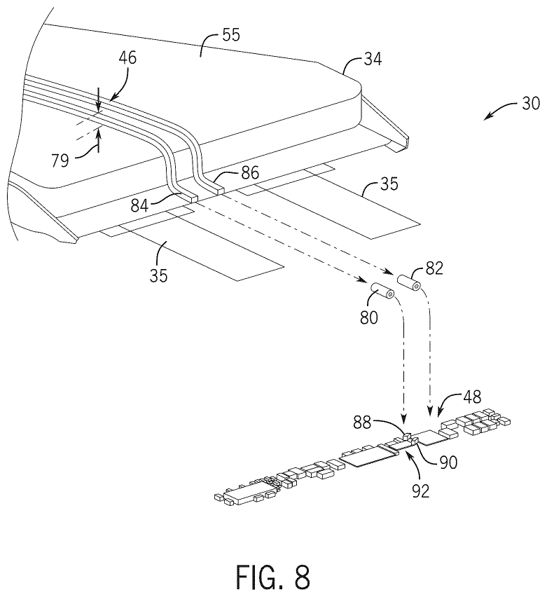

FIG. 8 is an exploded perspective view of an embodiment of a portion of the battery 30 of FIG. 2, including various features of the battery swelling detection assembly 32 (e.g., the conductive trace 46, the BMU 48, etc.). As shown, the battery 30 includes the conductive trace 46 disposed on the surface 55 of the enclosure 34. While the surface 55 in the illustrated embodiment is an outward facing (e.g., external) surface of the enclosure 34, in another embodiment, the surface 55 may be an inward facing (e.g., internal) surface of the enclosure 34. A thickness 79 of the conductive trace 46 (e.g., measured from the surface 55 outwardly) may be less than 100 microns, such as 20-100 microns, 30-90 microns, 40-80 microns, or 50-70 microns. In certain other embodiments, the thickness 79 may be less than 1000 microns. In any such embodiments, the conductive trace 46 does not substantially contribute to (e.g., increase) a footprint, size, or volume of the battery 30.

The conductive trace 46 is coupled to the BMU 48 via first and second connectors 80, 82. For example, a first end 84 of the conductive trace 46 is coupled to the first connector 80, and a second end 86 of the conductive trace 46 is coupled to a second connector 82. The first and second connectors 80, 82 are coupled to first and second electrical contacts 88, 90 integrated with the BMU 48. The BMU 48 may include, or be coupled with, additional components 92 (e.g., a sensor) configured to measure or otherwise determine the resistance in the conductive trace 46, as previously described.

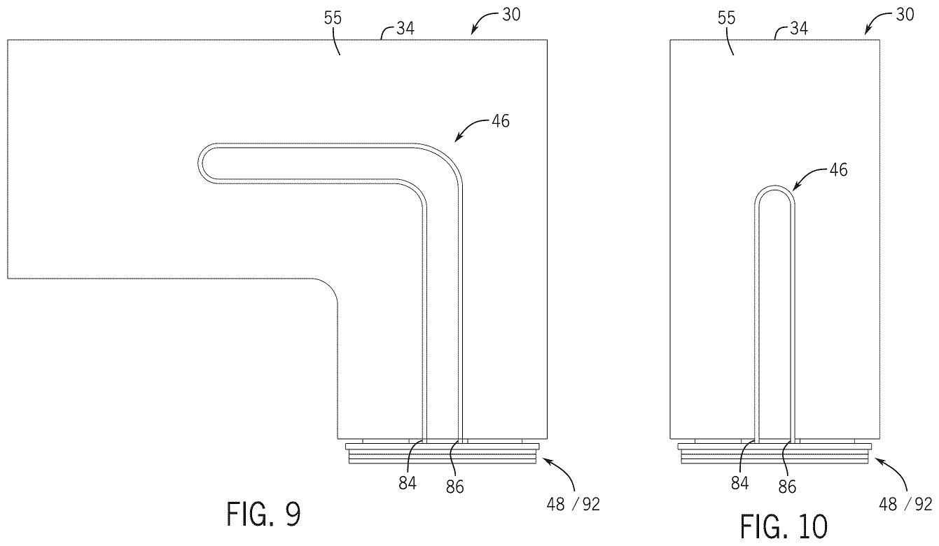

FIG. 9 is a front view of an embodiment of the battery 30 of FIG. 2, where the battery swelling detection assembly 32 includes the conductive trace 46 having an L-shape, and FIG. 10 is a front view of an embodiment of the battery 30 of FIG. 2, where the battery swelling detection assembly 32 includes the conductive trace 46 having a shape other than the L-shape in FIG. 9. For example, the shape of the conductive trace 46 in FIG. 10 may be referred to as a straight-line shape. The L-shape of the conductive trace 46 in FIG. 9 corresponds to an L-shape of the battery 30 in FIG. 9, and the straight-line shape of the conductive trace 46 in FIG. 10 corresponds to a straight-line shape of the battery 30 in FIG. 10. FIGS. 9 and 10 are included to demonstrate examples of how the shape of the conductive trace 46 may be optimized or otherwise designed for specific shapes of the battery 30. Other shapes of the conductive trace 46 and/or the battery 30 are also possible. Further, while the shapes of the conductive trace 46 and the battery 30 correspond in FIG. 9 and in FIG. 10, such correspondence may not be included in other embodiments. For example, in another embodiment, the battery 30 may include a straight-line shape while the conductive trace 46 may include an L-shape. In some embodiments, the shape of the conductive trace 46 may be designed to enable the percolation of the conductive particles of the conductive trace 46 regardless of a direction or orientation of swelling in the battery 30.

As previously described, the conductive trace 46 may include conductive particles, such as the conductive particles 56 illustrated in FIGS. 3 and 4. Various materials of the conductive trace 46 (e.g., of the conductive particles 56 illustrated in FIGS. 3 and 4) may be employed to facilitate the percolation affect, detection of changing resistance in response to the percolation affect, etc. FIG. 11 is a table including various materials that may be included in a conductive trace 46 (e.g., formed by conductive particles 56 illustrated, for example, in FIGS. 3 and 4) of the battery swelling detection assembly 32 of the battery 30 of FIG. 1.

For example, carbon-based materials 95 may be employed, having a composition of graphene, graphite, and/or carbon. Examples of such carbon-based materials 95 include graphene particles, carbon nanofibers, carbon nanotubes (e.g., single or multi-walled), etc. Additionally or alternatively, metal or metal alloy nanoparticles 96 may be employed, having a composition of any metallic compound. Examples of such metal or metal alloy nanoparticles 96 include silver, gold, platinum, nickel chromium, etc. Additionally or alternatively, non-metal nanoparticles 97 may be employed, having a composition of pure or doped metal oxides, carbides, nitrides, borides, sulfides, silicide, and/or halides. Examples of such non-metal nanoparticles 97 include indium tin oxide, doped-titania, doped-alumina, doped-zirconia, silicon carbide, etc. Additionally or alternatively, conductive polymers 98 may be employed, having a composition of polymeric materials. Examples of such conductive polymers 98 include Poly (3,4-ethylenedioxythiophene) (PEDOT), polyaniline, etc. Other materials of the same or similar class, composition, or material category may also be possible in accordance with present embodiments. In general, formula/composition may be single or multi-phase, including at least one electrically conductive phase having a conductivity (e.g., electronic and/or ionic conductivity) greater than 0.00000001 Siemens/centimeter (S/cm). An electrically insulating phase including a conductivity (e.g., electronic and/or ionic conductivity) less than 0.00000001 S/cm may also be used as a matrix, such as polymers (e.g., polyethylene, polypropylene, polystyrene, polyimide, etc.) and ceramics (e.g., pure alumina, pure silica, etc.).

Further, particles of the present disclosure (e.g., the conductive particles 56) may include spherical, disk-like, or cylindrical shapes, as previously described, where an aspect ratio of such particles may be less than, equal to, or greater than one. Presently disclosed sensing componentry may detect thickness variations (e.g., battery swelling), early signs of corrosion, and/or temperature variations. Further, the sensing componentry may include any suitable pattern with both endings (e.g., of the conductive trace 46) connected to the BMS, referred to in certain instances of the present disclosure as the BMU 48 (e.g., to form the closed-loop electrical path). Further still, the componentry may be integrated into the enclosure 34 either by directly printing onto the inner or outer surface 55 of the enclosure 34 or by laminating the componentry inside the construct of the enclosure 34.

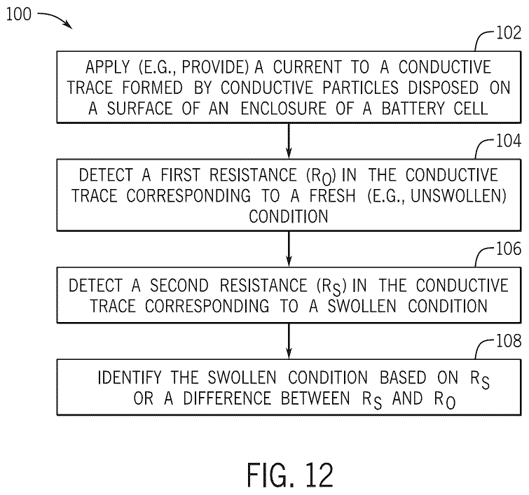

FIG. 12 is a process flow diagram illustrating an embodiment of a method 100 of detecting a swollen condition of the battery 30 of FIG. 2 via the battery swelling detection assembly 32 thereof. It should be noted that, in certain embodiments, not all of the steps of the method 100 described below are necessary. Further, it should be noted that the steps of the method 100 described below are not necessarily in a chronological order, as other chronological orders are also possible in accordance with the present disclosure.

The method 100 includes applying (block 102) (e.g., providing) a current to a conductive trace formed by conductive particles disposed on a surface of an enclosure of a battery. For example, a BMU of the battery may be electrically coupled with the conductive trace and configured to apply (e.g., provide) the current to the conductive trace. The method 100 also includes detecting (block 104) a first resistance (R₀) in the conductive trace corresponding to a fresh (e.g., unswollen) condition of the battery. That is, R₀ may be detected (e.g., via the BMU) when the battery is in the fresh (e.g., unswollen) condition. The method 100 also includes detecting (block 106) a second resistance (Rₛ) in the conductive trace corresponding to a swollen condition of the battery. That is, Rₛ may be detected (e.g., via the BMU) when the battery is in the swollen condition.

The method 100 also includes identifying (block 108) the swollen condition based on Rₛ or a difference between Rₛ and R₀. For example, in certain embodiments, the BMU may compare Rₛ with a threshold resistance and detect the swollen condition based on Rₛ exceeding the threshold resistance. Additionally or alternatively, in certain embodiments, the BMU may compare a difference between Rₛ and R₀ (e.g., a change in resistance) with a threshold resistance differential (e.g., a threshold resistance change) and detect the swollen condition based on the difference exceeding the threshold resistance differential. As previously described, the resistance in the conductive trace may change (e.g., increase) based on percolation of the conductive particles of the conductive trace responsive to swelling of the battery.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform] ing [a function] . . . ” or “step for [perform] ing [a function] . . . ,” it is intended that such elements are to be interpreted under 35 U.S.C. 112 (f). However, for any claims containing elements designated in any other manner, it is intended that such elements are not to be interpreted under 35 U.S.C. 112 (f).

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. A battery, comprising:
an enclosure;
a battery management unit (BMU); and
a conductive trace comprising a plurality of conductive particles disposed on a surface of the enclosure and electrically coupled with the BMU to form a closed-loop electrical path, wherein the BMU is configured to:
detect a resistance in the closed-loop electrical path caused by a percolation of the plurality of conductive particles; and
determine a swollen condition of the battery based on the resistance.

2. The battery of claim 1, wherein the BMU is configured to determine the swollen condition of the battery based on:
the resistance exceeding a threshold resistance; or
a change in the resistance exceeding a threshold change.

3. The battery of claim 1, wherein the conductive trace comprises carbon-based materials.

4. The battery of claim 3, wherein the carbon-based materials comprise graphene, graphite, or carbon.

5. The battery of claim 1, wherein the conductive trace comprises metal or metal alloy materials.

6. The battery of claim 5, wherein the metal or metal alloy materials comprise silver, gold, platinum, or nickel chromium.

7. The battery of claim 1, wherein the conductive trace comprises non-metal nanoparticles.

8. The battery of claim 7, wherein the non-metal nanoparticles comprise indium tin oxide, doped-titania, doped-alumina, doped-zirconia, or silicon carbide.

9. The battery of claim 1, wherein the conductive trace comprises conductive polymers.

10. The battery of claim 9, wherein the conductive polymers comprise poly (3,4-ethylenedioxythiophene) (PEDOT) or polyaniline.

11. The battery of claim 1, wherein a thickness of the conductive trace is less than 1000 microns.

12. A battery, comprising:
an enclosure; and
a percolation-based conductive trace comprising a plurality of conductive particles disposed on a surface of the enclosure; and
a battery management unit (BMU) coupled with the percolation-based conductive trace and configured to:
detect a resistance in the percolation-based conductive trace; and
determine a swollen condition of the battery based on the resistance.

13. The battery of claim 12, wherein the percolation-based conductive trace comprises carbon-based materials, pure metal materials, metal alloy materials, or any combination thereof.

14. The battery of claim 12, wherein the percolation-based conductive trace comprises non-metal nanoparticles, nonconductive polymers, or any combination thereof.

15. The battery of claim 12, wherein the BMU is configured to determine the swollen condition of the battery based on the resistance exceeding a threshold resistance.

16. The battery of claim 12, wherein the BMU is configured to:
determine whether an amount of swelling corresponding to the swollen condition exceeds a threshold amount; and
perform a control action based on the amount of swelling exceeding the threshold amount, the control action comprising communicating an alert, disconnecting the battery from a load, disconnecting the battery from a charging source, or any combination thereof.

17. One or more tangible, non-transitory, computer-readable media storing instructions thereon that, when executed by one or more processors, are configured to cause the one or more processors to:
detect a resistance in a closed-loop electrical path caused by a percolation of a plurality of conductive particles on a surface of a battery; and
determine a swollen condition of the battery based on the resistance.

18. The one or more tangible, non-transitory, computer-readable media of claim 17, wherein the instructions, when executed by the one or more processors, are configured to cause the one or more processors to communicate an alert indicative of the swollen condition, disconnect the battery from a load based on the swollen condition, or disconnect the battery from a charging source based on the swollen condition.

19. The one or more tangible, non-transitory, computer-readable media of claim 17, wherein the instructions, when executed by the one or more processors, are configured to cause the one or more processors to determine the swollen condition of the battery based on the resistance exceeding a threshold resistance.

20. The one or more tangible, non-transitory, computer-readable media of claim 17, wherein the instructions, when executed by the one or more processors, are configured to cause the one or more processors to determine whether an amount of swelling corresponding to the swollen condition exceeds a threshold amount.
